(19) United States
(12) Patent Application Publication
(10) Pub. No.: US 2002/0106480 A1
(43) Pub. Date: Aug. 8, 2002

(54) Stair treadcover

(76) Inventor: Jean-Pierre Vallieres, Lavaltrie (CA)

Correspondence Address: LESPERANCE & MARTINEAU, 1440 WEST, STE-CATHERINE ROOM 700, MONTREAL, QC, H3G1R8, CA

(21) Appl. No.: 10/075,240

(22) Filed: Feb. 15, 2002

Related U.S. Application Data
(60) Provisional application No. 60/266,446, filed on Feb. 6, 2001.

(51) Int. Cl. B32B 7/00

(52) U.S. Cl. 428/99; 428/120

(57) ABSTRACT

A floor mat for use over ground in subfreezing climates. The floor mat consists of a planar sheet having an exposed top face, a ground-engageable bottom face, and a peripheral edge portion. A plurality of studs, made from thermally conducting material, are integrally connected to the sheet and project upwardly from its exposed top face. A number of cavities are formed within the sheet in register with the studs, these cavities opening through the sheet bottom face and forming thermal wells. The studs are of such a length as to extend upwardly beyond the layer of ice overlying the floor mat, wherein the top free end tip of the studs will capture sun rays, and transfer radiative heat from the free end tip to the underlying air pocket cavities. Heat will build up in these air pocket cavities, thus promoting radiative transfers to the main body of floor mat, and thus, thaw of ice supported by the floor mat.

### CROSS REFERENCE DATA

This application claims convention priority based upon co-pending U.S. patent application Ser. No. 60/266,446 filed Feb. 6, 2001.

### FIELD OF THE INVENTION

This invention relates to floor mats, and more particularly, to stair treadcovers for use in subfreezing climates.

### BACKGROUND OF THE INVENTION

In sub-freezing climates found during winter in countries such as Canada, snow and ice gather on ground surfaces, and can render gait unpredictable at best, and even treacherous or worse during bad weather. Ground truth is especially a worry when snow and in particular ground ice cover outdoor staircases. Real estate managers and owners having properties with outdoor staircases, will be rightly concerned about civil liability that may be involved in not properly maintaining their staircases, particularly in the hours and days following a snow storm or ice storm.

One usual treatment for improving ground truth around outdoor staircases is to use a shovel, to remove accumulated snow, and/or to spread abrasive granular materials such as sand or salt that will sink into ground ice if any to fragment and dissolve same. Such treatment is obviously labour intensive, and the sand and salt material can add up to non-negligeable variable cost disbursements. Such abrasive granular materials have the undesirable effect of damaging the underlying staircase itself, as this abrasive material will also sink into for example the cement or wood making up the steps of the staircase, and thus eventually compromising the integrity of the staircase itself. At the very least, the abrasive material will quickly create a plurality of troughs in the exposed surface of the outdoor staircase steps, so that this exposed surface of the steps will not be planar anymore with time, wherein ground truth over the staircase steps will be compromised twelve months a year. Moreover, this abrasive material will also concurrently damage shoes, boots and pants of individuals that walk over these treated ground surfaces.

Removable jute carpet sheets are known to be used to cover outdoor staircase steps, to protect the steps from the abrasive materials damaging effects. Also, since jute includes water permeable pores, it allows water to seep therethrough, to promote good air circulation between the jute sheet and the ground surface.

Perforated rubber mats and carpets are also used to cover outdoor ground surfaces, including staircase steps.

When temperatures are well below freezing, even a sunny day will not bring about thaw of ground ice.

The problem with the above-noted known devices and methods for maintenance of outdoor staircases in sub-freezing climates, is that they are highly dependent upon labour availability. If no worker is available to treat the ice-laden ground, the problem will remain and will be compounded with time—making eventual treatment still more difficult—and will solve itself belatedly only when the thaw season arrives, which may be months later.

### OBJECTS OF THE INVENTION

The gist of the present invention is to improve upon existing floor mats for outdoor ground surfaces, especially staircases, for sub-freezing climates.

An important object of the present invention is to provide such an improved floor mat, that will allow an ice build-up thereover to automatically melt under the action of the sun, even in temperatures well below freezing.

A general object of the present invention is to provide such a floor mat, that will be cheap to manufacture and easy to use.

### SUMMARY OF THE INVENTION

In accordance with the objects of the invention, there is disclosed a floor mat for use over ground in subfreezing climates, said floor mat consisting of a planar sheet member having an exposed top face, a ground-engageable bottom face, and a peripheral edge portion; further including: a) a plurality of studs, said studs made from thermally conducting material and integrally connected to said sheet member and projecting upwardly from said top face thereof; and b) a number of cavities formed within said sheet member and extending upwardly into at least some of said studs, said cavities opening through a lower mouth at said sheet member bottom face and forming thermal sinks.

Preferably, said floor mat is made from a thermoplastic material. Each of said cavities may be inversely funnel shaped, or alternately, inversely V-shape. There may be as many said thermal sinks are there are said studs.

Preferably, each of said studs is generally tubular, with an intermediate conical section ending with a diametrally smallest free end tip (preferably cylindroid). Each of said studs could then be carried spacedly upwardly from said sheet member top face by a conical skirt, said skirt integral to said sheet member.

Preferably, said studs and said sheet material are made from the same material, most preferably a semi-flexible thermoplastic material. At least a few ground engaging spacer members could be added, projecting downwardly from said sheet member bottom face, and opening into said sheet member cavities, wherein shallow air circulation channels are formed in a gap beneath said sheet member bottom face above ground for free air circulation between said sheet member cavities and ground through said gap.

At least a few through-bores could be made at said peripheral edge portion thereof for engagement by attachment for fixedly securing said floor mat into the ground.

The invention also relates to a staircase treadcover for use against staircase steps in subfreezing climates, said treadcover consisting of a planar sheet member having an exposed top face, a ground-engageable bottom face, and a peripheral edge portion, a plurality of rigid studs being integrally connected to said sheet member and projecting upwardly from said top face thereof, said studs made from thermally conducting material, and thermal sink means being provided integrally with at least some of said studs and opening through a lower mouth at said sheet member bottom face.

The invention also relates to a floor mat for use over ground in subfreezing climates, said floor mat of thermally conducting material and having a main body with an exposed top face, a ground-engageable bottom face, and a peripheral edge portion, said floor mat further including: a) infra-red radiation capture means, integral to said floor mat top face for extending beyond and clearing an ice layer build-up thereover; b) heat sink means, in register with at least some of said infra-red radiation capture means and embedded within said floor mat main body; and c) thermal bridge means, operatively linking said infra-red capture means and said heat sink means for thermal transfers from said capture means to said sink means;

wherein a heat transfer from said sink means to said floor mat main body is enabled upon capture by said capture means of infra-red radiation.

Preferably, said heat sink means form air pocket cavities opening through said floor mat bottom face; and further including spacer means, integral with said floor mat bottom face and in fluid communication with said heat sink means, said spacer means for creating a gap between said floor mat and the ground wherein air circulation passageways are formed between said floor mat and the ground.

### DESCRIPTION OF THE DRAWINGS

FIGS. 1 and 2 are top and bottom perspective views respectively of the stair treadcover according to the present invention;

FIGS. 3 and 4 are enlarged, partial, cross-sectional perspective views of first and second embodiments respectively of the traction studs from the stair treadcover of FIG. 1;

FIG. 5 is an edge view at a larger scale of an end portion of the stair treadcover of FIG. 1; and

FIG. 6 is a perspective view of a staircase, showing two steps each partly covered by a stair cover according to the present invention.

### DETAILED DESCRIPTION OF THE EMBODIMENTS OF THE INVENTION

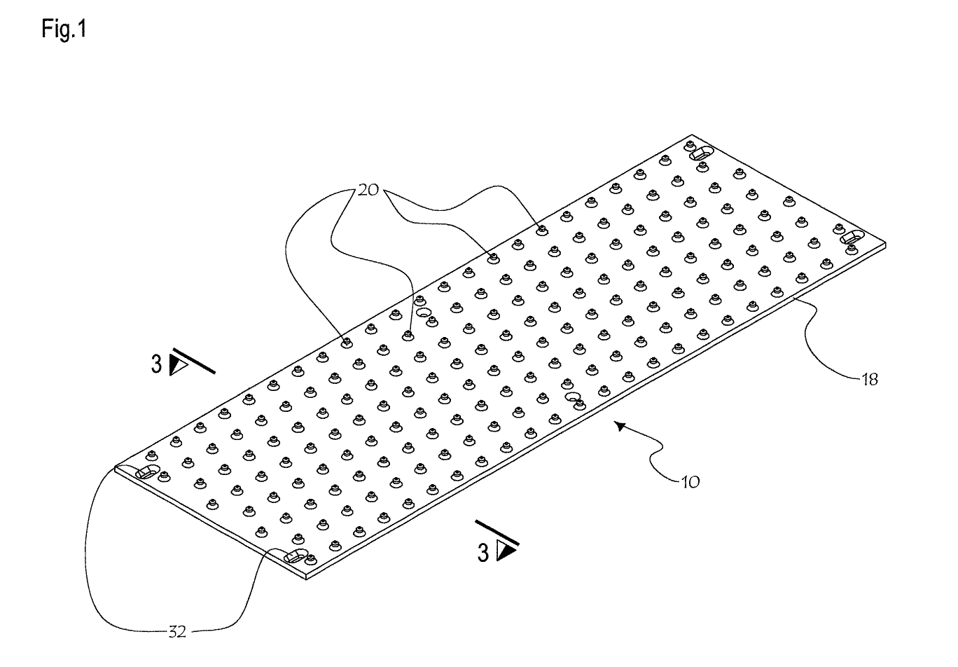

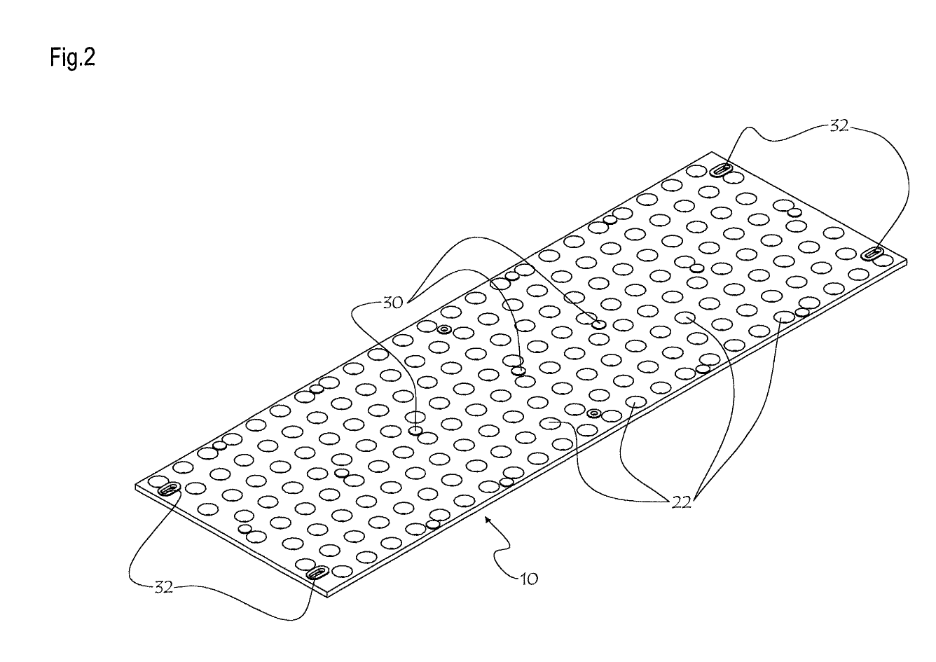

The floor mat shown in FIGS. 1 and 2 as 10, consists of a planar sheet member defining a main body 12 having an exposed top face 14, a ground-engageable bottom face 16, and a peripheral edge portion 18. Floor mat 10 should be made from a strong, weather resistant material. Sheet member main body 12, should further be made from a thermally conductive material, preferably semi-flexible, for example a thermoplastic material such as PolyVinyl Chloride (PVC) which can be injection molded. Floor mat 10 can be for example rectangular, as shown, with the thickness of sheet member main body 12 being for example a few millimeters. A plurality of thermally conducting studs 20 are integrally connected to the sheet member 12 and project upwardly from the top face thereof 14. A number of air pocket cavities 22 are formed within the main body 12 of sheet member, in register with corresponding studs 20, and open through the bottom face 16 of sheet member main body 12.

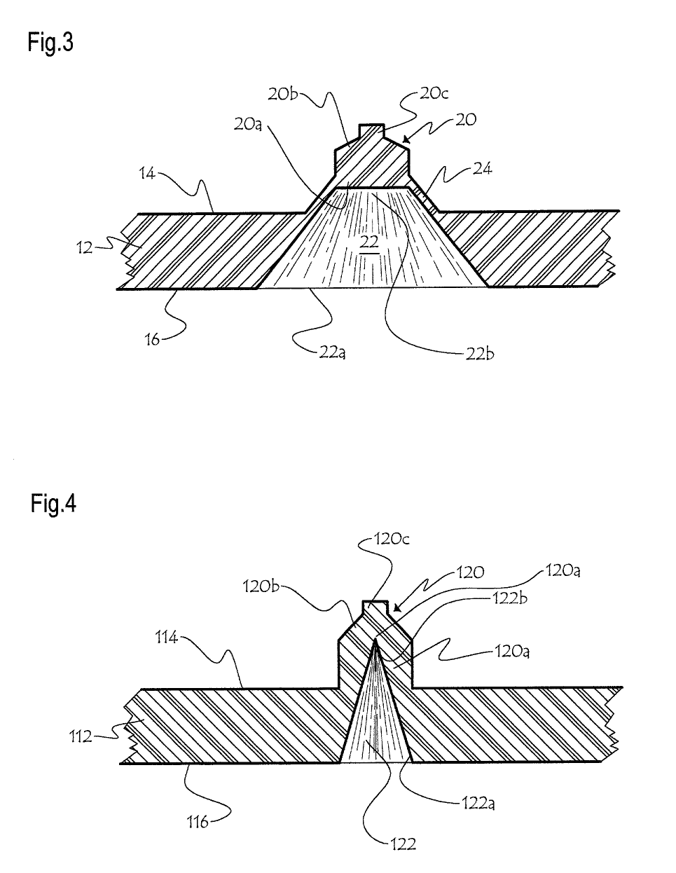

FIGS. 3 and 4 show in sectional view two different embodiments of studs 20, 120 respectively.

In the embodiment of FIG. 3, stud 20 is carried spacedly over the plane intersecting the exposed top face 14 of the sheet member, by a conical skirt 24. Stud 20 is generally tubular in shape, having a main diametrally largest lower section 20a, merging with skirt 24, an intermediate conical section 20b, and a top diametrally smallest free end tip 20c. Free end tip 20c is for example cylindroid. A generally inversely funnel shape for air pocket cavity 22 beneath stud 20 is illustrated with the top apex portion thereof 22b extending upwardly above the plane intersecting top face 14 of floor mat sheet 12. However, other generally conical shapes would be acceptable for cavity 22, provided the lower mouth 22a (coplanar with the sheet member bottom face 16) of the cavity 22 is diametrally larger than the top inner end 22b thereof (adjacent the stud lower section 20a), for a reason detailed hereinbelow.

In the embodiment of FIG. 4, the base of stud 120 is coplanar to the exposed top face 114 of the sheet member. Stud 120 is again generally tubular in shape, having a main diametrally largest lower section 120a, an intermediate conical section 120b, and a top diametrally smallest free end tip 120c. Free end tip 120c is again for example cylindroid. A generally inversely V-shape air pocket cavity 122 is formed beneath stud 120 is illustrated with the top apex end portion thereof 122b, again extending upwardly above the plane intersecting top face 114 of floor mat sheet 112. However, other generally conical shapes would be acceptable provided the lower mouth 122a (coplanar with the sheet member bottom face 116) of the cavity 122 is diametrally larger than the top inner end 122b thereof (adjacent the stud lower section 120a), for a reason detailed hereinbelow.

Studs 20 or 120 may have other suitable shapes, provided the stud diameter generally increases from its exposed outer end 20c, 120c to its inner end 20a, 120a. During tests performed by the present invention, the diameter of the stud top exposed nipple 20c was between approximately 10 and 20% that of the stud base tubular section 20a, when thermal differentials observed during sunny days between ambiant air and air trapped inside the air pocket cavities 22,122 were an unexpectedly high 10° Celsius. However, it is to be understood that exposed nipple 20c is not critical to the ice thaw and ice and snow melting process of this floor mat 10, since it is designed to wear off and eventually disappear from repeated use of the floor mat.

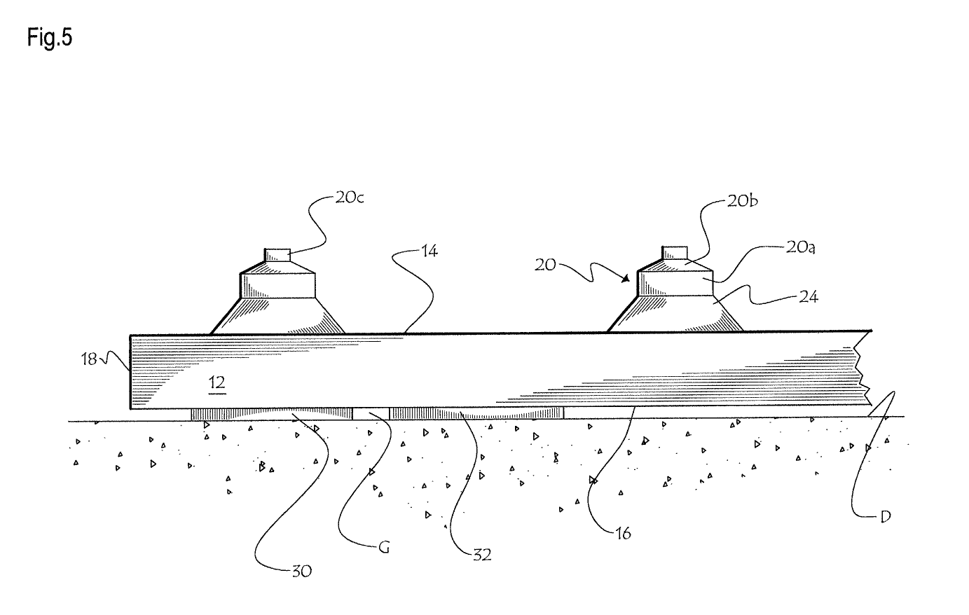

As illustrated in FIGS. 2 and 5, a number of spacer elements 30 are fixedly mounted against the bottom face 16 of the sheet member main body 12. Each spacer element 30 is located intermediate a pair of successive air pocket cavities 22. The number, distribution and thickness of spacer elements 30 should be such, in relation to the size of the sheet member main body 12, as to create a shallow gap G between the sheet member main body 12 and the underlying ground D, with this gap forming air circulation passageways between body 12 and ground D. The circulation of air through gap G will enable removal of moisture thereabout.

The height of gap G could be for example half a millimeter. Also, warm air from the heated air pockets 22, 122 will be able to seep through gap G, and thus warming up also the underface 16, 116, of the floor mat main body 12, 112 respectively.

Through bores 32 may be made at the comers of the peripheral edges 18 of sheet member 12, for passage of anchoring elements for anchoring the sheet member 12 against an underlying ground surface. These through bores 32 may be for example ovoidal, to accommodate thermal expansion of the floor mat main body 12 during hot summer time climates.

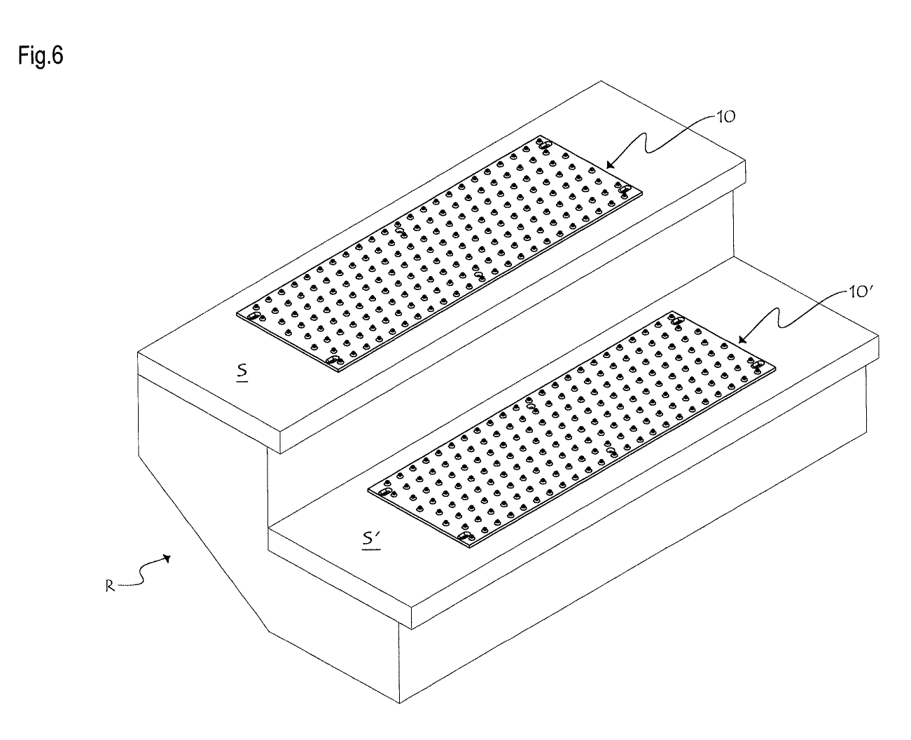

FIG. 6 illustrates one example of how two floor mats 10, 10′, can be made to cover two steps S, S′, from a staircase R.

It can now be readily understood the studs 20 should be of such a length that their top nipple 20c and at least an upper portion of the intermediate section 20b extend upwardly beyond the thickness of ice layer having built up over the floor mat 10. The length of each stud 20 may be for example about twice the thickness of the floor mat sheet member main body 12. The diametrally very small size of these exposed stud nipples 20c, as well as the inclined slopes of the intermediate conical stud sections 20b, will make it very unlikely that any freezing rain weather could allow ice to crystalize thereabout and enable ice build-up therearound. This plurality of studs 20 projecting upwardly will further work as a bed of nails, providing excellent anti-skid properties against both ice and snow.

Moreover, once sunny days return, even in still subfreezing temperatures, the top ice-free exposed nipples 20c and conical stud sections 20b of the studs 20 will then be able to capture sun rays, and transfer heat from the infra-red component of the sun rays to the air pocket cavities 22 via the thermally conductive body of the studs 20. Accordingly, the main body of studs 20 work as thermal bridges between the stud sections 20c and 20b, exposed to ambiant air and to sun rays, and the air trapped inside cavities 22. Therefore, heat will build up inside these air pocket cavities 22, so that cavities 22 form heat sinks. Radiative heat transfer from the heat sink cavities 22 to the main body 12 of floor mat 10 will follow via heat convection through gap G and mat underface 12, and thus eventually, thaw of the layer of ice overlying the floor mat and consequent melting of snow and ice over the floor mat 10. If a cement tile or the like form the ground surface beneath the floor mat 12, 112, they will also be heated by heat convection from heat sinks 22, thus providing a second heat sink to eventually accelerate thaw over mat 12, 112.

It has been discovered by the present inventor that, during sunny days in sub-freezing temperatures, a thermal differential of up to 10° Celsius have been observed between outside ambiant air and the thermal sink air pockets 22 of floor mat 10.

Although the floor mat according to the present invention is particularly well adapted for use over outdoor ground surfaces in sub-freezing climates, it could also be used indoors, for example inside a garage where oil and grease can fall to the ground. Residential as well as commercial uses are envisioned.

1. A floor mat for use over ground in subfreezing climates, said floor mat made from thermally conducting material and consisting of a planar sheet member having an exposed top face, a ground-engageable bottom face, and a peripheral edge portion; and further including:
a) a plurality of studs, integrally connected to said sheet member and projecting upwardly from said top face thereof, and
b) a number of cavities formed within said sheet member and extending upwardly into at least some of said studs, said cavities opening through a lower mouth at said sheet member bottom face and forming thermal sinks, said studs forming thermal bridges between said thermal sinks and ambiant air.

2. A floor mat as in claim 1,
wherein said floor mat is made from a thermoplastic material.

3. A floor mat as in claim 1,
wherein each of said cavities is inversely funnel shaped.

4. A floor mat as in claim 1,
wherein each of said cavities is inversely V-shape.

5. A floor mat as in claim 1,
wherein there are as many said thermal sinks as there are said studs.

6. A floor mat as in claim 1,
wherein each of said studs is generally tubular, with an intermediate conical section ending with a diametrally smallest free end nipple.

7. A floor mat as in claim 6,
wherein each of said studs is carried spacedly upwardly from said sheet member top face by a conical skirt, said skirt integral to said sheet member.

8. A floor mat as in claim 1,
wherein said studs and said sheet material are made from sturdy semi-flexible thermoplastic material.

9. A floor mat as in claim 1,
wherein each of said studs is generally tubular, having a length of about twice the thickness of said sheet member main body.

10. A floor mat as in claim 1,
further including at least a few ground engaging spacer members, projecting downwardly from said sheet member bottom face and opening into said sheet member cavities, wherein shallow air circulation channels are formed beneath said sheet member bottom face for free air circulation between said sheet member cavities and ground through said air circulation channels.

11. A floor mat as in claim 6,
wherein said nipple forms a heat capture element having a diameter ranging between about 10 and 20% that of a diametrally largest section of said stud.

12. A floor mat as in claim 1,
further including at least a few through-bores, made at said peripheral edge portion thereof for engagement by attachment for fixedly securing said floor mat into the ground.

13. A floor mat as in claim 7,
wherein each of said cavities is inversely funnel shaped.

14. A floor mat as in claim 6,
wherein each of said cavities is inversely V-shape.

15. A staircase treadcover for use against staircase steps in subfreezing climates, said treadcover of thermally conducting material and consisting of a planar sheet member having a main body with an exposed top face, a ground-engageable bottom face, and a peripheral edge portion, a plurality of rigid heat capture and thermal transfer studs being integrally connected to said sheet member and projecting upwardly from said top face thereof, said studs made from thermally conducting material, and air pockets forming thermal sink means within said sheet member main body and in register with respective at least some of said studs and opening through a lower mouth at said sheet member bottom face.

16. A staircase treadcover as in claim 15,
further including spacer means, mounted to said sheet member bottom face, for creating a gap between said treadcover air pockets and the ground, wherein air circulation passageways are defined between said treadcover and the ground through said gap.

17. A staircase treadcover as in claim 15,
wherein there are as many said air pockets are there are said studs.

18. A treadcover as in claim 15,
wherein each of said studs is generally tubular, having a length of about twice the thickness of said sheet member main body.

19. A floor mat for use over ground in subfreezing climates, said floor mat of thermally conducting material and having a main body with an exposed top face, a ground-engageable bottom face, and a peripheral edge portion, said floor mat further including:
a) infra-red radiation capture means, integral to said floor mat top face for extending beyond and clearing an ice layer build-up thereover;
b) heat sink means, in register said infra-red radiation capture means and embedded within said floor mat main body; and
c) thermal bridge means, operatively linking said infra-red capture means and said heat sink means for thermal transfers from said capture means to said sink means;
wherein a heat transfer from said sink means to said floor mat main body is enabled upon capture by said capture means of infra-red radiation.

20. A floor mat as in claim 19,
wherein said heat sink means form air pocket cavities opening through said floor mat bottom face; and further including spacer means, integral with said floor mat bottom face, said spacer means for creating a gap between said floor mat and the ground wherein air circulation passageways are formed between said floor mat and the ground, wherein said air pocket cavities and said air circulation passage ways are in thermal exchange fluid communication with one another.
